(19) United States
(12) Patent Application Publication
(10) Pub. No.: US 2010/0241300 A1
(43) Pub. Date: Sep. 23, 2010

(54) COMPUTER-IMPLEMENTED SQUEAK DETECTION METHOD AND SYSTEM

(75) Inventors: Venkat Rao Aekka, Canton, MI (US); Martin Arthur Trapp, Novi, MI (US); Alan George David Fisk, Farmington Hills, MI (US); Julie Downing Roehner, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/405,326

(22) Filed: Mar. 17, 2009

(51) Int. Cl. G01M 17/00; G06F 17/50

(52) U.S. Cl. 701/29; 703/1

(57) ABSTRACT

In one embodiment, a computer program identifies potential squeak concerns between vehicle component pairs. The program includes instructions for receiving CAD data. The program also includes instructions for identifying vehicle component pairs having components within a predetermined tolerance of each other. For each component pair, a material description to each of the components and a material compatibility value is assigned. Material compatibility values are then outputted to identify squeak concerns.

### BACKGROUND

1. Technical Field

One or more embodiments of the present invention relate to a computer-implemented method and system for detecting potential squeak conditions between components, and in certain embodiments analytical squeak detection in vehicle component pairs.

2. Background

In today's technological age, hand drawn diagrams of vehicle designs previously used by the Original Equipment Manufacturers (OEM) and their vehicle suppliers have been replaced by computer-aided engineering (CAE) tools. OEMs and suppliers can use these tools to determine optimal design parameters for their products. For example, CAE tools can be used to pinpoint problem areas (e.g., rattles and squeaks) in a vehicle design, isolate the problem area, and resolve the problem to prevent any potential noise in the final product. The prior art contains various examples of such automated methods and systems for detecting noises in a vehicle. Some examples include: U.S. Pat. No. 6,101,432 issued to Her et al. directed to a vehicle rattle detection method and system, U.S. Pat. No. 6,892,568 issued to Witer et al. directed to a noise detection system and method, U.S. Pat. No. 5,551,298 issued to Rayment directed to an identification of vibration induced noises on vehicles, U.S. Pat. No. 7,289,635 B2 issued to Naganarayana et al. directed to a structural noise source predictor, U.S. Publication No. 2003/0088346 A1 issued to Calkins et al. directed to a noise, vibration and harshness analyzer, U.S. Pat. No. 3,748,896 issued to Barrows directed to a vibrator unit for testing a motor vehicle for rattles and squeaks.

Notwithstanding the availability of these tools, at some point over a vehicle's lifetime, an owner may still have some problem or concern with their vehicle. Among the various concerns, squeaks and rattles heard during the operation and use of the vehicle are a couple of examples. At least one reason for these noises is because parts that are frictionally incompatible due to their material types may be paired together and placed in the final product.

Not so often, during vehicle design, an OEM may examine the material type of vehicle component pairs before implementation. If an assessment is made, it is conducted manually on a part by part basis. Manually assessing which parts are incompatible, however, can be a time consuming and expensive analysis particularly since a vehicle is usually comprised of thousands of parts. Accordingly, determining material incompatibility of vehicle component parts can be an onerous initiative for many OEMs. Furthermore, because of the financial and time investment associated with manually examining each part, OEMs conduct material incompatibility assessments on an ad hoc basis. Accordingly, there are no milestones to serve as checkpoints for verifying material compatibility and the accuracy of identifying incompatible components is, therefore, significantly reduced.

While the prior art illustrates in various ways how to detect squeaks and rattles in a vehicle using CAE tools, it does not show, however, noise detection by determining material incompatibility of vehicle components using CAE tools. The various embodiments presented herein, therefore, can at a minimum provide for less or no noise in the final product and, accordingly, reduce the customer dissatisfaction associated with vehicle use due to these persistent noises generated by their vehicle.

### SUMMARY

One aspect of the present invention is a computer program product embodied in a computer readable medium for identifying potential squeak concerns between a pair of vehicle components. The computer program product includes computer readable instructions for receiving computer aided design (CAD) data. The CAD data represents a number of vehicle components and a position for each of the number of vehicle components. In some embodiments, the CAD data may include bill of materials data representing material types of which the number of vehicle components are made. The computer program product further includes instructions for identifying a number of vehicle component pairs. Each component within the pair is within a predetermined tolerance of each other based on the CAD data. For example, in some embodiments, the components may be within a tolerance of about −3 mm to +2 mm.

The computer program product further includes computer readable instructions for assigning a material description to each of the components in the vehicle component pair for each of the number of vehicle component pairs. Additionally, the computer program product includes instructions for assigning a material compatibility value based on the material description of each component for each of the number of vehicle component pairs. The computer program product further includes instructions for outputting the material compatibility values for each of the vehicle component pairs for use in identifying squeak concerns.

In some embodiments, the material description assigned to each of the components in the vehicle component pair may be a plastic.

In some embodiments, the computer program product includes instructions for identifying potential galvanic corrosion concerns between at least one of the number of vehicle components pairs. The material description assigned to each of the components in the vehicle component pair is a metal.

The computer program product further includes instructions for verifying if the material descriptions are up to date. If not, instructions are sent for updating the material descriptions.

Another aspect of the present invention is a computer implemented method for identifying potential squeak concerns between a pair of vehicle components. The computer implemented method includes receiving CAD data. The CAD data represents a plurality of vehicle components and a position for each of the plurality of vehicle components. In some embodiments, the CAD data may include bill of materials data representing material types of which the number of vehicle components are made. The method further includes identifying a number of vehicle component pairs. Each pair has a first and second component within a predetermined tolerance of each other based on the CAD data. For example, in some embodiments, the components may be within a tolerance of about −3 mm to +2 mm.

The method further includes assigning a material description to each of the components in each of the number of vehicle component pairs. The method further includes assigning a material compatibility value for each vehicle component pair based on the material description for each component in each of the number of vehicle component pairs. The method further includes outputting the material compatibility values for each of the vehicle component pairs for use in identifying squeak concerns.

In some embodiments, the method includes generating a report of the identified squeak concerns.

In some embodiments, the method includes receiving CAD data for generating a visual illustration of a vehicle assembly. The method further includes receiving data representing the identified squeak concerns for visually illustrating the squeak concerns with respect to the vehicle assembly. The method further includes generating a visual illustration of the vehicle assembly based on the CAD data and the identified squeak concerns.

In some embodiments, the material description assigned to each of the components in the vehicle component pair is a plastic.

In some embodiments, the method further includes identifying potential galvanic corrosion concerns between at least one of the number of vehicle components pairs. The material description assigned to each of the components in the vehicle component pair is a metal.

Another aspect of the present invention is a computer implemented system comprising at least one computer capable of identifying potential squeak concerns between a pair of vehicle components. The at least one computer is configured to receive CAD data. The CAD data represents a number of vehicle components and a position for each of the number of vehicle components. In some embodiments, the CAD data may include bill of materials data representing material types of which the number of vehicle components are made. The at least one computer is further configured to identify a plurality of vehicle component pairs. Each pair has a first and second component within a predetermined tolerance of each other based on the CAD data.

The at least one computer is further configured to assign a material description to each of the first and second components in each of the number of vehicle component pairs. The at least one computer is further configured to assign a material compatibility value based on the material description of the first and second components for each of the number of vehicle component pairs. The at least one computer is further configured to output the material compatibility values for each of the vehicle component pairs for use in identifying squeak concerns.

In some embodiments, the at least one computer is further configured to generate a report of the identified squeak concerns.

In some embodiments, the at least one computer is further configured to receive CAD data for generating a visual illustration of a vehicle assembly. The at least one computer is further configured to receive data representing the identified squeak concerns. The received data is for visually illustrating the squeak concerns with respect to the vehicle assembly. The at least one computer is further configured to generate a visual illustration of the vehicle assembly based on the CAD data and the identified squeak concerns.

In some embodiments, the material description assigned to each of the components in the vehicle component pair may be a plastic.

In some embodiments, the at least one computer is further configured to identify potential galvanic corrosion concerns between at least one of the number of vehicle components pairs. The material description assigned to each of the components in the vehicle component pair is a metal.

In some embodiments, the at least one computer is further configured to verify if the material descriptions are up to date. If not, instructions are sent for updating the material descriptions.

These and other aspects of the present invention will be better understood in view of the attached drawings and following detailed description of the invention.

### BRIEF DESCRIPTION OF THE DRAWINGS

The features of the present invention which are believed to be novel are set forth with particularity in the appended claims. The present invention, both as to its organization and manner of operation, together with further object and advantages thereof, may best be understood with reference to the following description, taken in connection with the accompanying drawings, which:

FIG. 1 represents a computer system for squeak detection based on material incompatibility according to one of the various embodiments of the present invention.

FIG. 2 represents a method of squeak detection based on material incompatibility according to one of the various embodiments of the present invention.

FIG. 3 represents an example of determining material incompatibility values according to one of the various embodiments of the present invention.

FIG. 4 represents an example of a graphical user interface (GUI) for squeak detection based on material incompatibility according to one of the various embodiments of the present invention.

FIG. 5 represents an example of a graphical user interface (GUI) for squeak detection based on material incompatibility according to another one of the various embodiments of the present invention.

FIG. 6 represents an example of a generated report for squeak detection based on material incompatibility according to one of the various embodiments of the present invention.

FIG. 7 represents an example graphical visualization for squeak detection based on material incompatibility according to another one of the various embodiments of the present invention.

### DETAILED DESCRIPTION OF ONE OR MORE EMBODIMENTS OF THE PRESENT INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

A typical design and engineering process includes steps to manufacture a number of automotive parts which are included in a vehicle. Technology has afforded product development teams the benefit of various tools to assist in the design and engineering process. For example, one well known set of tools are computer aided engineering (CAE) tools in which computer graphics are used to replace sketches and drawings traditionally used to visualize the product development process. Such tools can also assist a product development team to assess optimal design parameters. While these tools are helpful, there exists a need to provide a computer-implemented squeak detection method and system for detecting potential squeak conditions between components based on material incompatibility.

In one or more embodiments, the present invention is directed at a method and system of analytical squeak detection based on material incompatibility. While the various embodiments are presented in the context of a vehicle design development, such embodiments may also be useful for product development in other industries where noise from material pairing of components is of concern. Furthermore, while the various embodiments are presented in the context of determining concerns between plastic components, it is equally applicable to determining non-limiting concerns between components made up of other nonlimiting materials such as metal, rubber, paint and/or a combination of various materials (e.g. plastic and metal).

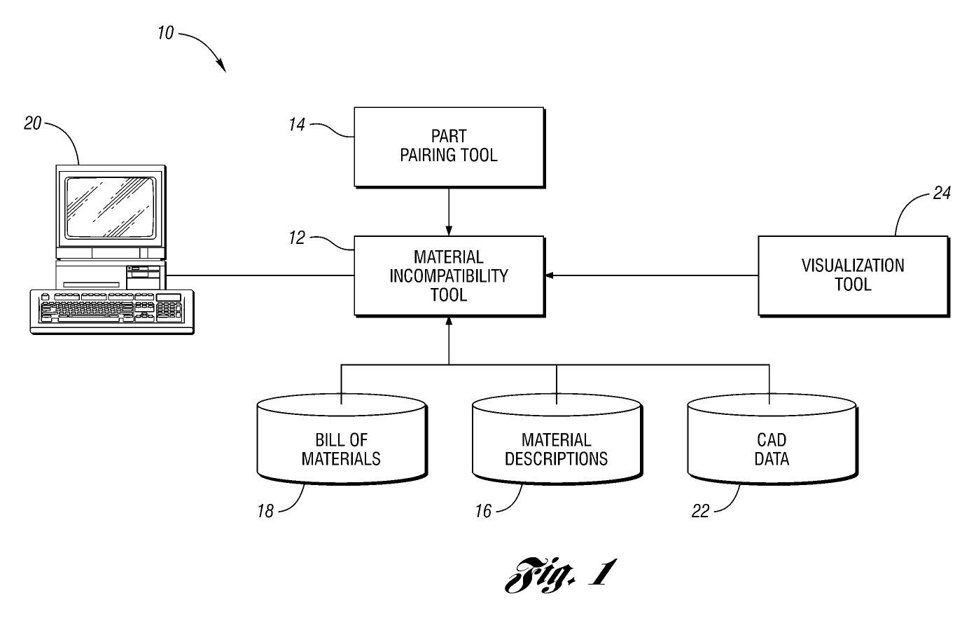

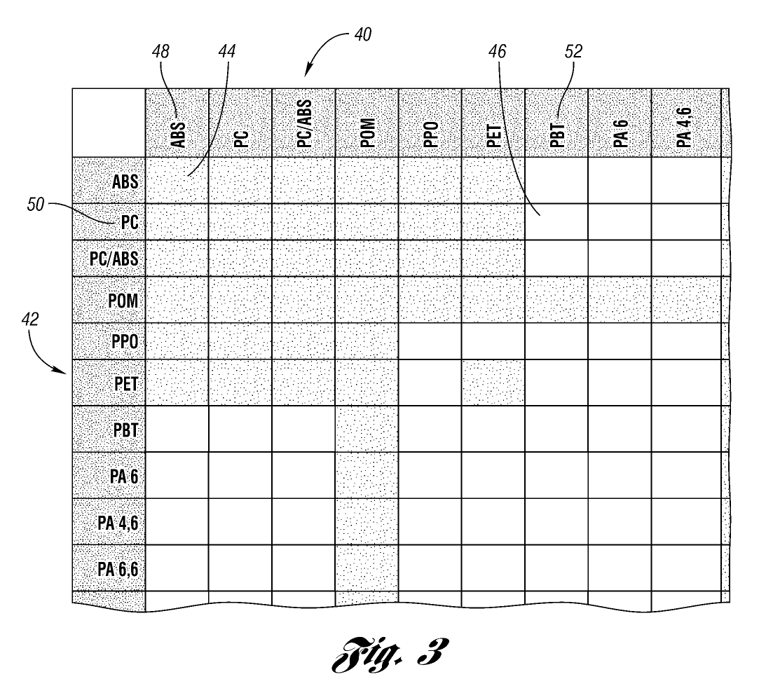

FIG. 1 shows a computer system for squeak detection based on material incompatibility according to one of the various embodiments of the present invention. Computer system 10 may include a computer program product 12 (hereinafter referred to as tool 12) embodied in a computer readable medium for identifying potential squeak concerns between a pair of vehicle components. Tool 12 may be stored on a user terminal 20 or stored on and accessed through a remote server (not shown). Tool 12 may have inputs and outputs programmed to the tool 12 for assigning a material compatibility value to the first and second components of each vehicle component pair. In one embodiment, the inputs and outputs may comprise a data matrix (see FIG. 3). As will be further described below, material compatibility values may be outputted for identifying squeak concerns.

The computer system 10 may also include a data file 22 (e.g., a database) from which the computer program product 12 may receive computer aided design (CAD) data. The CAD data may represent a number of vehicle components and a position for each of the number of vehicle components. Data file 22 may be capable of receiving, storing, and updating CAD data. Furthermore, data file 22 may be any file capable of being stored that can be used as input and/or written as output. For example, in one embodiment, data file 22 may be an external computer program product in communication with computer system 10. In one embodiment, data file 22 may be in communication with data file 18 such that the CAD data received by computer program product 12 may include bill of material data from data file 18.

Computer system 10 may also be in communication with data file 18 (e.g., a database) from which computer program product 12 may receive a plurality of material types making up the vehicle components. Material types may include, but are not limited to, the types of materials within the plastic, rubber, metal and paint families. In one embodiment, data file 18 may include at least one data field populated with a plurality of vehicle components (identified by, for example, a plurality of part numbers) and at least one other data field populated with the material type of which each of the respective vehicle components is made. Additionally, in another embodiment, there may be a first data file 18 for assigning the first and second vehicle component to a material type and a second data file 16 in communication with data file 18 for assigning a material description to the first and second vehicle components. Material descriptions in data file 16 may refer to, for example, the generic family to which a vehicle component made of a particular material type belongs. Data in data file 18 may be updated and uploaded regularly and/or according to a predetermined time schedule with or without human intervention. For example, data may be uploaded and updated four weeks prior to one or more product (e.g., vehicle) development milestones.

Communicating further with computer program product 12 of computer system 10 may be a second computer program product 14 for determining a tolerance between each vehicle component of the vehicle component pairs. One of ordinary skill in the art will know how to calculate tolerances between vehicle components and/or program the tolerance calculations to computer program product 14. In one embodiment, computer program product 14 may be a separate component of computer system 10 and clearance/tolerance data may be accessed/retrieved from a separate data file (not shown). In another embodiment, computer program product 12 and computer program product 14 may be programmed and communicating as one component of computer system 10. In yet another embodiment, computer program product 14 may be a data file (not shown) storing tolerance data for each vehicle component pair and the data may be programmatically retrieved by tool 12. Furthermore, computer program product 14 may be housed in one terminal 14, separate terminals or in a remote terminal accessible via a computer network (not shown).

Computer system 10 may also be in communication with another computer program product (hereinafter referred to as tool 24). Tool 24 may be used to visually illustrate the identified squeak concerns. Accordingly, the squeak concerns may be identified virtually, without physical embodiments of the vehicle. The identified squeak concerns may be transmitted electronically or may be manually inputted to tool 24 for further analysis.

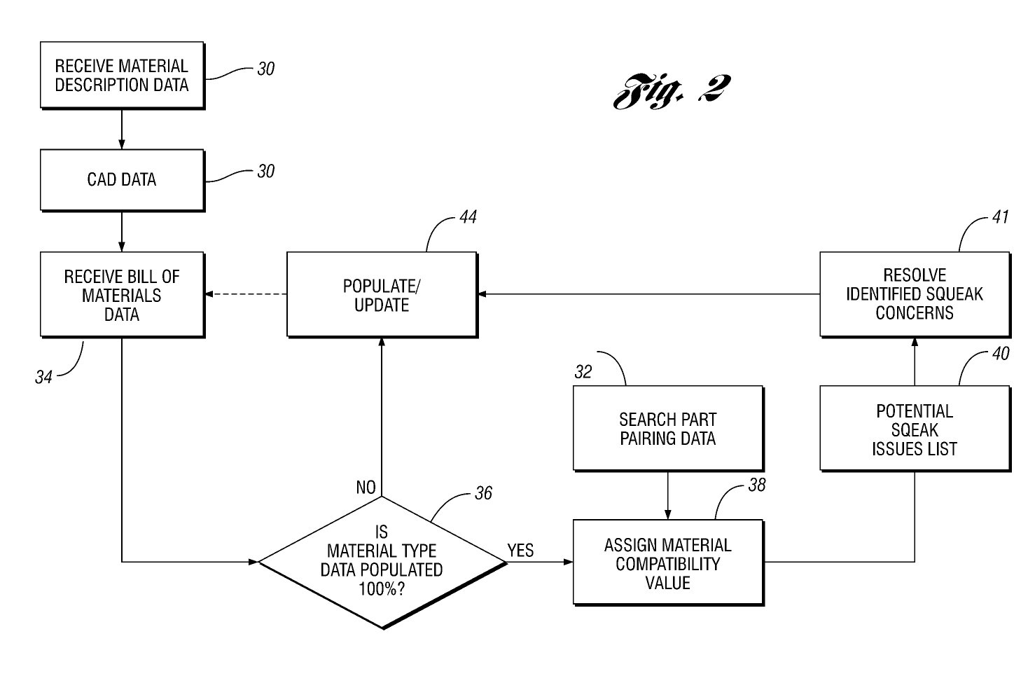

In another embodiment of the present invention, a computer-implemented method of identifying potential squeak concerns between a pair of vehicle components is disclosed. FIG. 2 illustrates the method according to one of the various embodiments of the present invention. Computer program product 12 may receive material description data as in block 30 for assigning a material description to the first and second components of the vehicle component pairs. Material descriptions may also be referred to as material families of the vehicle components. Material description data may be inputted before, after, or simultaneously with component pairing data into computer program product 12.

Computer program product 12 may also receive bill of materials data as in block 30. Bill of materials data may be received from data file 18 and computer program product 12 may be programmed with computer readable instruction to receive the bill of materials data. Bill of materials data in data file 18 may be populated by the product manufacturer (e.g., an Original Equipment Manufacturer or “OEM”). Computer program product 12 may also receive CAD data as in block 31. CAD data may be received from data file 22 as populated by a product manufacture (e.g. an OEM). CAD data may represent a plurality of vehicle components and a position for each of the plurality of vehicle components.

In block 32, pairing data of vehicle components may be identified. Each pair has a first and second component within a predetermined tolerance of each other. The tolerance values may serve as a filter for identifying potential squeak concerns between vehicle component pairs. The filter may be inputted to computer program product 12. For example, in one embodiment, the filter (i.e., tolerance) may be set to −3 mm interference to +2 mm clearance between mating parts. Accordingly, the vehicle components outputted from computer program product 12 as falling within this filter range example are, therefore, considered “touching” and generating a potential squeak concern.

The product (e.g., vehicle) components may be associated with material type data which may be stored in a data file (e.g., data file 18). Material type data may be updated and uploaded regularly or according to a predetermined time schedule as in block 36. For example, data may be uploaded and updated four weeks prior to one or more product (e.g., vehicle) development milestones. The updated material type data may include the most recent component material content in order to, for example, avoid missing detecting incompatible component materials. If the material type data has not been fully populated with the most recent data as in block 36, the material type data file 18 may be required to be updated as in block 44. The update may be accomplished automatically or with human intervention. In one embodiment, an automatically generated electronic mail (email) message may be sent to one or more users (e.g. engineers) responsible for updating the data who may manually update the information.

If the material type data has been fully populated as in block 36, the computer program product 12 may then assign a material compatibility value (e.g., value 44 or value 46 of FIG. 3) to the product (e.g., vehicle) component pairs as in block 38. Assignment of material compatibility values (e.g., value 44 or value 46) may be accomplished through an array comprised of data elements as illustrated in FIG. 3. In one embodiment, the array may be a matrix as represented in FIG. 3. There may a first array 40 and a second array 42 associated with the assigned material descriptions of the first and second components. In one embodiment, as exemplified in FIG. 3, the material descriptions of the first array 40 and the second array 42 may be organized into material types. The first array 40 and second array 42 may be comprised of data elements (e.g., data element 48 and data element 50, respectively) associated with the material type (or material description) of the first and second components of the vehicle component pairs. Nonlimiting examples of material types may include: acrylonitrile butadiene styrene (ABS), polycarbonate (PC), polyoxymethylene (POM), polyphenylene oxide (PPO), polyethylene terethphalate (PET), polybutylene terethphalate (PBT), polyamide 6 (PA 6), and polyamide 4,6 (PA 4,6).

The first array 40 and second array 42 may not be limited to a particular configuration. For example, first array 40 may represent the first component and second array 42 may represent the second component. Alternatively, first array 40 may represent the second component and second array 42 may represent the first component. Upon assigning the first and second product (e.g., vehicle) components to a data element 48 in the first array 40 and a data element 50 in the second array 42, computer program product 12 may use the assigned data elements 48, 50 as inputs for outputting material compatibility values 44, 46 for each of the vehicle component pairs in order to identify squeak concerns.

Data element 44 may represent incompatible pairs and data element 46 may represent compatible pairs. In one embodiment, data elements 44, 46 may be color-coded values (e.g., red may represent incompatible pairs and green may represent compatible pairs). It should be understood that compatibility/incompatibility of component pairs may be represented in numerous ways and is not limited to color-coded values and/or specific colors. For example, a component pair to be assessed in making the interior trim panel of a vehicle may be made of data element 48 (e.g., acrylonitrile butadiene styrene (ABS)) for the first component and data element 50 (polycarbonate (PC)) for the second component. Based on ABS and PC as the materials making up the vehicle component pair, computer program product 12 may algorithmically generate material compatibility value 44 as an output. The algorithm may be pre-programmed to computer program product 12 with human intervention. Material compatibility value 44 may indicate that the use of ABS and PC for mating parts would potentially generate a squeak concern (represented by, e.g., being colored red). Additionally or alternatively, computer program product 12 may generate material compatibility value 46 as an output when mating vehicle component pairs made of data element 50 and data element 52. Thus, mating polycarbonate (PC) for the first component with polybutylene terethphalate (PBT) for the second component may indicate material compatibility of the vehicle components. Material compatibility value 46 may indicate that the use of PC and PPT for mating parts would potentially generate a lower squeak concern (represented by, e.g., being colored green). It should be understood that compatibility/incompatibility of component pairs may be represented in numerous ways and is not limited to color-coded values and/or specific colors.

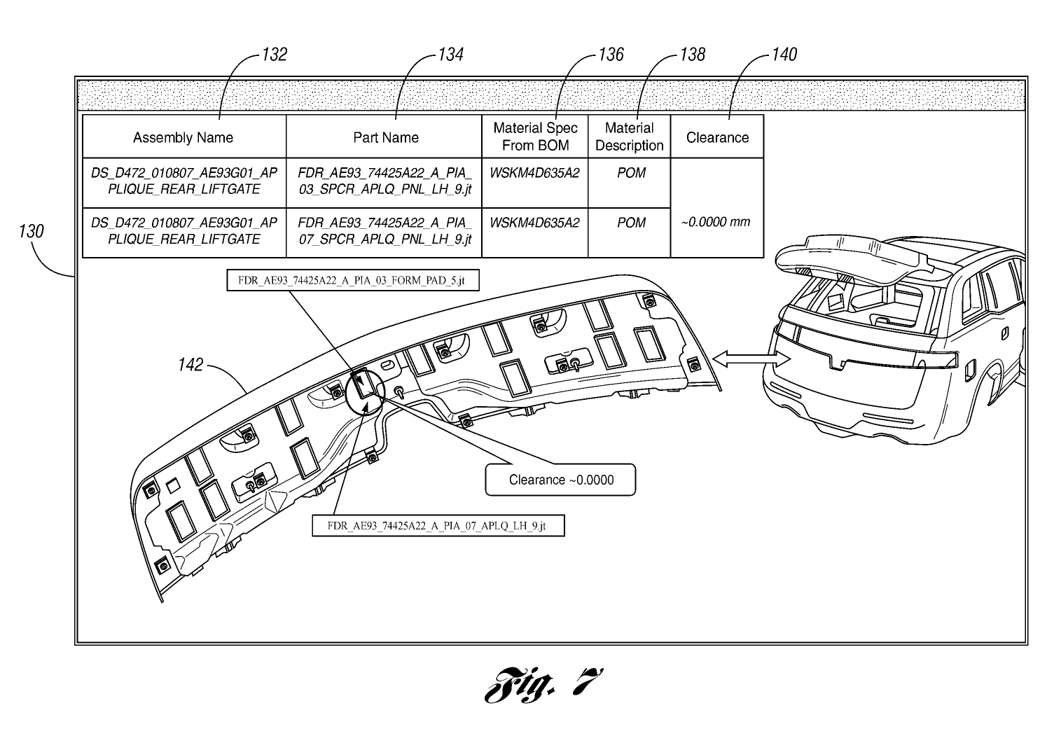

In one embodiment, referring back to FIG. 2, a report of squeak concerns may be generated as in block 40 based on the outputted material compatibility values. The report may be electronic, paper, or in any other form known in the art. The report may be used to identify squeak concerns. In a further embodiment, the report may be further used to resolve the identified squeak concerns as in block 41. For example, the identified squeak concerns may be resolved by isolating the components having the concerns. In another example, the identified squeak concerns may be resolved by providing sufficient design clearance between the mating components. Alternatively, the squeak concerns may be identified virtually for providing a visualized representation of the squeak concern and then resolved using, for example, human intervention. For example, the identified squeak concerns may be transmitted or inputted into and received by tool 24. Tool 24 may generate one or more graphical representations of a vehicle assembly having the component pairs with the squeak concerns. FIG. 7 (described below) shows one example of a virtual identification of squeak concerns according to one of the various embodiments of the present invention.

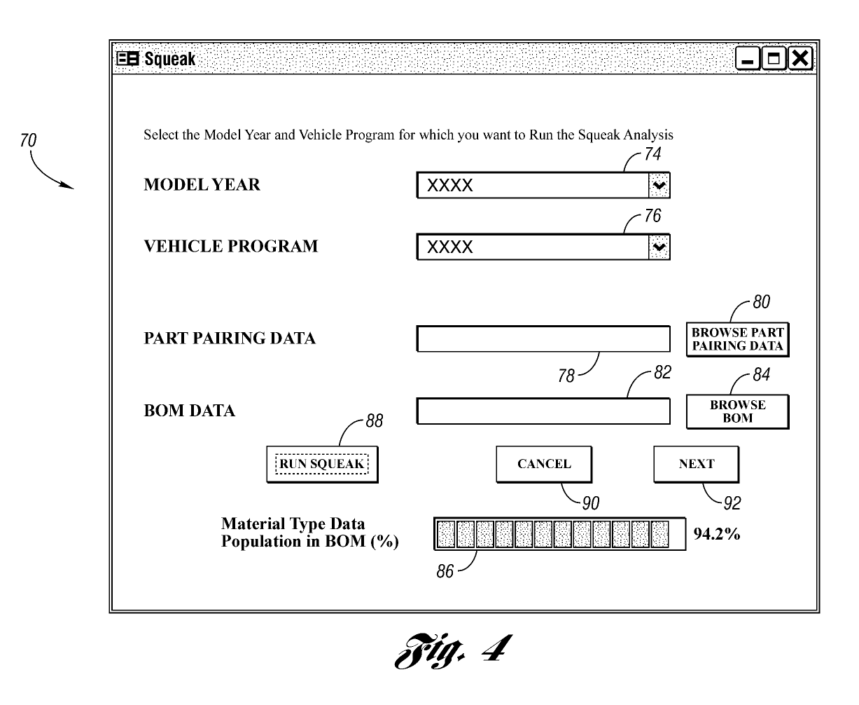

FIG. 4 shows one example of a graphical user interface (GUI) for detecting squeak concerns based on material incompatibility according to one of the various embodiments of the present invention. GUI 70 may include data field 74 and data field 76 associated with the model year of the vehicle and vehicle type, respectively, for which a squeak concern analysis is being conducted using tool 12. Data pertaining to component pairs for which a squeak concern analysis is being sought may be inputted into data field 78. Pairing data may originate from data file 14 and may be accessed by selecting selectable button 80. Pairing data may be organized according to model year and vehicle type. Therefore, pairing data in data field 78 may pertain to the model year and vehicle type as inputted in data field 74 and data field 76, respectively.

Data pertaining to the material types (i.e. bill of materials data) for each component of the component pairs may be inputted into data field 82. Bill of materials data may originate from data file 18 and may be accessed by selecting selectable button 84. Bill of materials data may be organized according to model year and vehicle type. Therefore, bill of materials data in data field 82 may pertain to the model year and vehicle type inputted in data field 74 and data field 76, respectively.

Selectable button 88 may be selected when at least one of the data fields 74, 76, 78, 82 have been inputted with the appropriate information. It should be understood that at least one data field should be populated but it is not necessary that all data fields be populated prior to selecting selectable button 88. Selecting selectable button 88 may cause tool 12 to identify the squeak concerns based on the inputted data. Selectable button 90 may also be selected which may cause the present operation of tool 12 to terminate and tool 12 itself to close. Selectable button 92 may be selected to move to the next GUI for further operation.

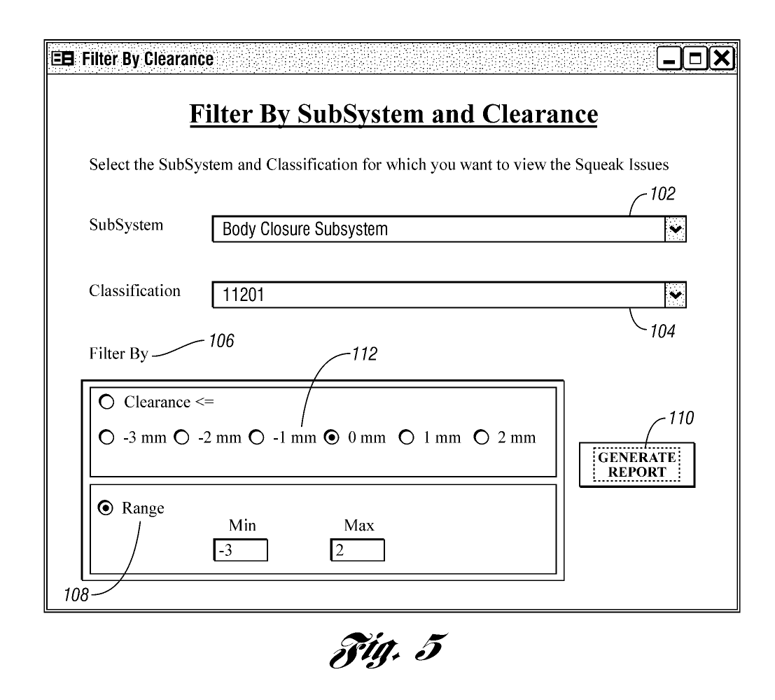

FIG. 5 represents a further example of a GUI for squeak detection based on material incompatibility according to one of the various embodiments of the present invention. GUI 100 may be configured to allow a user to select filters for identifying the component pairs potentially having squeak concerns according to the inputted filters. In one embodiment, some non-limiting filters for identifying the component pairs having potential squeak concerns may include filter 102 which may be associated with a vehicle's subsystem (e.g., the location of the component pairs such as the body closures), filter 104 which may be associated with a vehicle component classification system in which groups of vehicle components may be classified using, for example, a numerical classification scheme, and/or filter 106 which may be the tolerance clearance or range of the mating parts. Tolerance filter 106 may be inputted through a number of numerical options 112 displayed on GUI 100. Alternatively, tolerance filter 106 may be inputted as a range 108. Upon determining filters 102, 104, 106, 108, and/or 112, a report may be generated by selecting selectable button 110.

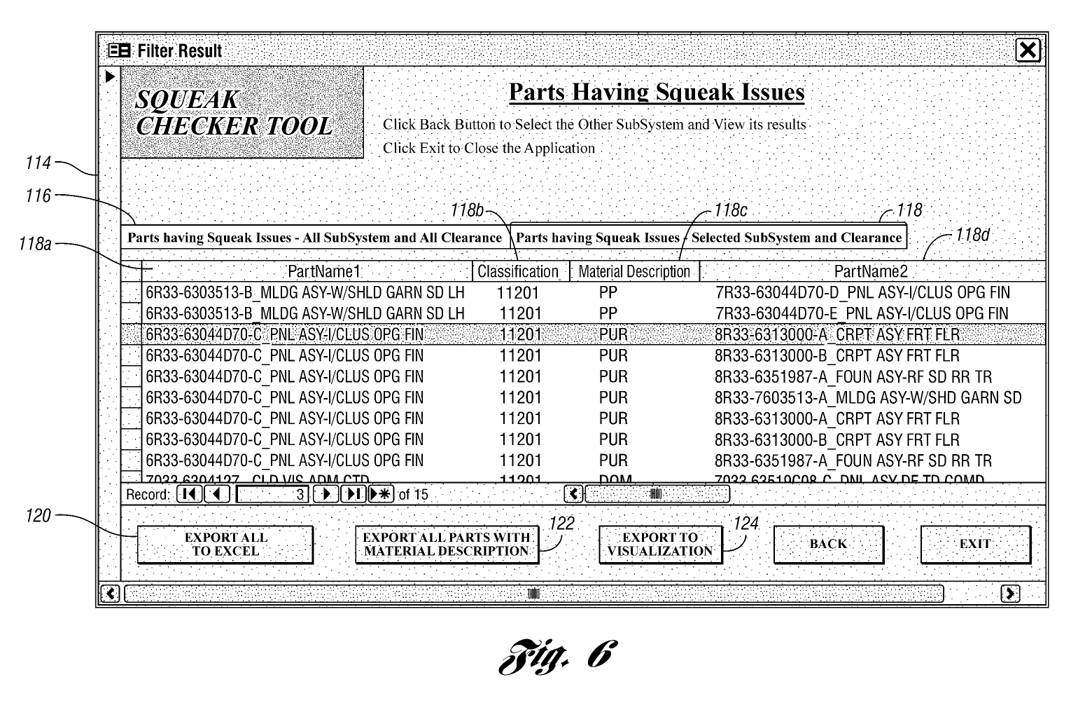

One example of a generated report is represented in FIG. 6 according to one of the various embodiments of the present invention. GUI 114 may be based on the tolerance data of the component pairs and the material incompatibility data (FIG. 3) described above. GUI 114 may include one or more tabs. The tabs may relate to the filtered or non-filtered data regarding the identified squeak concerns. For example, tab 116 may be non-filtered information regarding identified squeak concerns and, therefore, provide results relating to all product components without a tolerance filter. Tab 118 may be filtered information regarding identified squeak concerns and, therefore, provide results relating to specific locations (e.g., subsystems) of a product having a certain tolerance filter.

FIG. 6 further shows, according to one embodiment, the detail of information of the data upon selecting tab 116 or 118. Field 118a and 118d may be associated with the first and second components of the product pair that may have a potential squeak concern. Field 118c may be associated with the material description of the component pair. Field 118b may be associated with the vehicle component classification system described above with respect to FIG. 5. GUI 114 may further include selectable buttons 120 and 122 for exporting the data to an external program (e.g., EXCEL spreadsheet software available from Microsoft Corp.). Output generated from selection of selectable button 120 and 122 may be used for further analysis or record keeping. Selectable button 122 may provide a comprehensive record of component pairs identified as having squeak issues including their assigned material descriptions. Selectable button 124 may be selected to generate a visualized representation of the squeak concerns based on the CAD data and material type data.

FIG. 7 shows an exemplary representation of the visualization feature according to one of the various embodiments of the present invention. GUI 130 may be a visual representation of the output of material compatibility values for each of the product (e.g., vehicle) component pairs. GUI 130 may accomplish visual identification of the identified squeak concerns. For example, tool 24 may receive data for generating a visual illustration 142 of a vehicle assembly. The data may be CAD data. Tool 24 may also receive data relating to the squeak concerns of the product (e.g., vehicle) component pairs. The received squeak data may be the name of the assembly 132 having the component pairs, the name of the individual components 134 making up the assembly, the material type of the component 136 and its material description 138, and the tolerance between the components 140. Data 132, 134, 136, 138, 140 may be compiled with the visual illustration 142 for identifying one or more areas on the vehicle assembly having the squeak concerns. Tool 24 may be programmed to receive data 132, 134, 136, 138 and 140 for generating the visual illustration via communication with system 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer program product embodied in a computer readable medium for identifying potential squeak concerns between a pair of vehicle components, the computer program product comprising computer readable instructions for:
receiving computer aided design (CAD) data representing a plurality of vehicle components and a position for each of the plurality of vehicle components;
identifying a plurality of vehicle component pairs, each pair having a first and second component within a predetermined tolerance of each other based on the CAD data;
for each of the plurality of vehicle component pairs, assigning a material description to each of the first and second components;
for each of the plurality of vehicle component pairs, assigning a material compatability value based on the material description for the first and second components; and
outputting the material compatibility values for each of the vehicle component pairs for use in identifying squeak concerns.

2. The computer program product of claim 1 wherein the computer readable instructions for receiving CAD data include instructions for receiving bill of materials data representing a plurality of material types making up the plurality of vehicle components.

3. The computer program product of claim 1 wherein the predetermined tolerance level is in a range of about −3 mm to +2 mm.

4. The computer program product of claim 1 wherein the computer readable instructions for assigning a material description to each of the first and second components include assigning a material description of a plastic material to the first and second components.

5. The computer program product of claim 1 wherein the computer readable instructions further include identifying potential galvanic corrosion concerns between at least one of the plurality of vehicle components pairs and wherein the instructions for assigning a material description to each of the first and second components further include assigning a material description of a metal material to the first and second components.

6. The computer program product of claim 1 further comprising computer readable instructions for verifying if the material descriptions are up to date and, if not, transmitting instructions for updating the material descriptions.

7. A computer-implemented method for identifying potential squeak concerns between a pair of vehicle components, the computer implemented method comprising:
receiving computer aided design (CAD) data representing a plurality of vehicle components and a position for each of the plurality of vehicle components;
identifying a plurality of vehicle component pairs, each pair having a first and second component within a predetermined tolerance of each other based on the CAD data;
for each of the plurality of vehicle component pairs, assigning a material description to each of the first and second components;
for each of the plurality of vehicle component pairs, assigning a material compatibility value based on the material description for the first and second components; and
outputting the material compatibility values for each of the vehicle component pairs for use in identifying squeak concerns.

8. The computer-implemented method of claim 7 wherein the step of receiving the CAD data further includes receiving bill of materials data representing a plurality of material types making up the plurality of vehicle components.

9. The computer-implemented method of claim 7 further comprising generating a report of the identified squeak concerns.

10. The computer-implemented method of claim 7 further comprising:
receiving CAD data for generating a visual illustration of a vehicle assembly;
receiving data representing the identified squeak concerns for visually illustrating the squeak concerns with respect to the vehicle assembly; and
generating a visual illustration of the vehicle assembly based on the CAD data and the identified squeak concerns, wherein one or more areas on the vehicle assembly having the identified squeak concern are identified using the visual illustration.

11. The computer-implemented method of claim 7 wherein the predetermined tolerance level is in a range of about −3 mm to +2 mm.

12. The computer-implemented method of claim 7 wherein assigning a material description to each of the first and second components includes assigning a material description of a plastic material to the first and second components.

13. The computer-implemented method of claim 7 further comprising identifying potential galvanic corrosion concerns between at least one of the plurality of vehicle components pairs, wherein assigning a material description to each of the first and second components further includes assigning a material description of a metal material to the first and second components.

14. A computer-implemented system comprising at least one computer capable of identifying potential squeak concerns between a pair of vehicle components, the computer implemented system comprising at least one computer configured to:
receive computer aided design (CAD) data representing a plurality of vehicle components and a position for each of the plurality of vehicle components;
identify a plurality of vehicle component pairs, each pair having a first and second component within a predetermined tolerance of each other based on the CAD data;
for each of the plurality of vehicle component pairs, assign a material description to each of the first and second components;
for each of the plurality of vehicle component pairs, assign a material compatibility value based on the material description for the first and second components; and
output the material compatibility values for each of the vehicle component pairs for use in identifying squeak concerns.

15. The computer-implemented system of claim 14 wherein the CAD data includes bill of materials data representing a plurality of material types making up the plurality of vehicle components and the at least one computer is further configured to receive the bill of materials data.

16. The computer-implemented system of claim 14 wherein the at least one computer is further configured to generate a report of the identified squeak concerns.

17. The computer-implemented system of claim 14 wherein the at least one computer is further configured to:
receive CAD data for generating a visual illustration of a vehicle assembly; and
receive data representing the identified squeak concerns for visually illustrating the squeak concerns with respect to the vehicle assembly;
generate a visual illustration of the vehicle assembly based on the CAD data and the identified squeak concerns, wherein one or more areas on the vehicle assembly having the identified squeak concern are identified using the visual illustration.

18. The computer-implemented system of claim 14 wherein the at least one computer configured to assign a material description to each of the first and second components is configured to assign a material description of a plastic material to the first and second components.

19. The computer-implemented system of claim 14 wherein the at least one computer is further configured to identify potential galvanic corrosion concerns between at least one of the plurality of vehicle components pairs and wherein the assigned material description of the first and second components is a metal material.

20. The computer-implemented system of claim 14 wherein the at least one computer is further configured to verify if the material descriptions are up to date and, if not, send instructions for updating the material descriptions.
